(19) United States
(12) Patent Application Publication
(10) Pub. No.: US 2021/0156762 A1
(43) Pub. Date: May 27, 2021

(54) PIVOTABLE TRANSMISSION

(71) Applicants: ZF Friedrichshafen AG, Friedrichshafen (DE); ZF WIND POWER ANTWERPEN N.V., Lommel (BE)

(72) Inventor: Bart CAERS, Dessel (BE)

(21) Appl. No.: 16/628,074

(22) PCT Filed: Jun. 4, 2018
(86) PCT No.: PCT/EP2018/064599

§ 371 Date: Jan. 2, 2020

(30) Foreign Application Priority Data
Jul. 4, 2017 (DE) 10 2017 211 352.9

(51) Int. Cl. G01M 13/025; F16H 1/16; F03D 17/00

(52) U.S. Cl. CPC G01M 13/025; F16H 1/16; F05B 2260/4031; F05B 2260/83; F03D 17/00

(57) ABSTRACT

A transmission (101) with a rotatable structure (119), a first shaft (103) and a second shaft (105). The first shaft (103) and the second shaft (105) can be, respectively, an input shaft or an output shaft of the transmission (101). The first shaft (103) and the second shaft (105) are mounted to rotate in the rotatable structure (119). A rotational axis of the first shaft (103) and a rotational axis of the rotatable structure (119) are identical, and a rotational axis of the second shaft (105) and the rotational axis of the rotatable structure (119) are spaced apart from one another.

This application is a National Stage completion of PCT/EP2018/064599 filed Jun. 4, 2018, which claims priority from German patent application serial no. 10 2017 211 352.9 filed Jul. 4, 2017.

### FIELD OF THE INVENTION

The invention relates to a transmission.

### BACKGROUND OF THE INVENTION

From the prior art so-termed ‘back-to-back’ test rigs for wind-power transmissions are known. In a back-to-back test rig two units being tested are placed opposite each other and coupled in a rotationally fixed manner with their input shafts. A motor drives the output shaft of one of the test units. The output shaft of the other test unit is coupled to a generator.

The structure and dimensions of the units being tested can vary. Accordingly, the motor and the generator have to be designed to be movable both vertically and horizontally. This is achieved by elaborate platforms on which the motor and the generator are fixed. The platforms account for a substantial fraction of the actual cost of such a test rig.

### SUMMARY OF THE INVENTION

The purpose of the present invention is to eliminate the disadvantages inherent in the systems known from the prior art. In particular a test rig for wind-power transmissions should be provided, which is inexpensive.

This objective is achieved by the transmission and an arrangement according to the independent claim(s).

The transmission comprises a rotatable structure, a first shaft and a second shaft. Preferably, the structure can be rotated by any desired angle about just one rotational axis, or if necessary, more than one rotational axis. The angle can in particular be at least 360°.

The first shaft and the second shaft are kinematically coupled. Preferably, the shafts are positively coupled, i.e. with a transmission degree of freedom of 1. A general definition of the term transmission degree of freedom, otherwise called the transmission running degree, is to be found in “Dubbel” (K.-H. Grote, J. Feldhusen: “Dubbel”, 22nd edition 2007).

The first and second shafts are in each case either an input shaft or an output shaft. Thus, either the first shaft is an input shaft and the second shaft an output shaft, or the first shaft is an output shaft and the second shaft an input shaft.

Input and output shafts are characterized in that they project out of a housing of the transmission and are accessible from the outside, so that they can be connected rotationally fixed to further shafts or rotatable components. The input shaft serves to introduce torque into the transmission. Correspondingly, the output shaft serves to conduct torque out of the transmission. In this way a torque flow takes place from the input shaft to the output shaft.

According to the invention, the first shaft and the second shaft are mounted to rotate in the rotatable structure. In particular, the first shaft and the second shaft can rotate relative to the rotatable structure.

A rotational axis of the first shaft and a rotational axis of the rotatable structure are identical. Thus, rotation of the first shaft and rotation of the rotatable structure take place about a common rotational axis. As a result of this, during rotation of the rotatable structure the position of the first shaft remains unchanged.

In contrast, the second shaft is arranged eccentrically relative to the rotatable structure. A rotational axis of the second shaft and the rotational axis of the rotatable structure are a distance apart from one another. This means that the rotational axis of the second shaft and the rotational axis of the rotatable structure do not intersect. In particular, the rotational axis of the second shaft and the rotational axis of the rotatable structure are not identical. Preferably, the two rotational axes are parallel to one another.

As a result of the eccentric arrangement of the second shaft, during rotation of the rotatable structure the rotational axis of the second shaft describes a circular path about the rotational axis of the rotatable structure. Thus, by rotating the rotatable structure, it is possible to change the position of the second shaft. When the transmission according to the invention is used in a test rig, the above-described platform is obsolete. A corresponding test rig is described below.

In a preferred further development the transmission has a first gearwheel and a second gearwheel, which mesh with one another. The first gearwheel is connected rotationally fixed to the first shaft and the second gearwheel is connected rotationally fixed to the second shaft. By varying the size of the first and second gearwheels, not only the transmission ratio of the transmission but also the displacement range of the second shaft can be varied.

Moreover, the transmission can be developed further with a third shaft. The third shaft too is an input or an output shaft. The third shaft is of the same type as the second shaft. If the second shaft is an input shaft, then the third shaft is also in the form of an input shaft. Conversely, if the third shaft is an output shaft, then the second shaft too is an output shaft.

Like the second shaft, so too the third shaft is mounted to rotate in the rotatable structure and is arranged eccentrically relative to the rotatable structure. A rotational axis of the third shaft and the rotational axis of the rotatable structure are thus a distance apart from one another. Moreover, the rotational axis of the third shaft preferably extends parallel to the rotational axis of the rotatable structure. By virtue of the third shaft there are many more possible configurations of a test rig with the transmission concerned.

In a preferred further development the third shaft is integrated in the transmission by virtue of a third gearwheel, which is connected in a rotationally fixed manner to the third shaft. The third gearwheel meshes with the first gearwheel or with the second gearwheel.

In another preferred further development, a first part of a housing of the transmission constitutes the rotatable structure. The first part is mounted to rotate in a second part of the housing.

The housing of a transmission generally denotes a casing that encapsulates the other components of the transmission. The components of the transmission other than the housing are located at least partially inside the housing. Usually, the shafts of the transmission are also mounted in the housing.

The transmission according to the invention and its preferred further developments are suitable for use in a transmission test rig. A corresponding arrangement for testing a transmission—a first transmission unit to be tested—comprises a first transmission. The first transmission is a transmission according to the invention or a preferred further development thereof. An input or output shaft of the first transmission unit to be tested can be connected in a rotationally fixed manner to the second shaft or, if one is present, to the third shaft of the first transmission.

Preferably, the arrangement is developed further by a drive input unit with a drive input shaft and/or a drive output unit with a drive output shaft. The drive input shaft or the drive output shaft is connected in a rotationally fixed manner to the first shaft of the first transmission. By rotating the rotatable structure, the position of the second shaft and, if one is present, that of the third shaft can be adapted to the structural circumstances of the first transmission unit to be tested, so that its input or output shaft can be connected rotationally fixed to the second shaft or, if appropriate, to the third shaft of the first transmission.

In a preferred further development the arrangement comprises at least one horizontally mobile platform. The platform can be displaced or moved in translation in the horizontal direction. The first transmission and/or the drive input and/or the drive output are on the platform, preferably fixed thereto. Thus, by virtue of the platform the first transmission and/or the drive input and/or the drive output, can also be moved horizontally. In this way the horizontal positioning range of the second shaft can be optimized.

For the vertical positioning of the second shaft, the range that can be covered by rotating the rotatable structure seems to be sufficient. Accordingly, no provision need be made for the vertical displacement of the platform. This saves costs compared with the test rigs known from the prior art.

The arrangement is preferably developed further as a back-to-back test rig for receiving a second transmission unit to be tested. The first transmission unit to be tested and the second transmission unit to be tested have the same structure. Thus, they are identical transmissions.

Two components are said to have the same structure when their physical parameters match to within manufacturing tolerance ranges—in particular in relation to their material and geometrical properties.

The input shaft of the first transmission unit to be tested and an input shaft of the second transmission unit to be tested are connected rotationally fixed to one another. According to this further development it is provided that the output shaft of the first transmission unit to be tested should be connected rotationally fixed to the second shaft or, if present, to the third shaft of the first transmission. For this, the position of the second shaft or, if appropriate, that of the third shaft of the first transmission, is adapted by rotating the rotatable structure of the first transmission and if necessary moving the platform.

In a preferred further development, the second transmission unit to be tested, as well, is incorporated into the test rig by way of a transmission according to the invention. A corresponding arrangement comprises a second transmission with the characteristics of the invention. Preferably, the first transmission and the second transmission are structurally identical. According to this further development the drive input shaft of the drive unit is connected rotationally fixed to the first shaft of the first transmission. The drive output shaft of the drive output is connected in a rotationally fixed manner to the first shaft of the second transmission.

### BRIEF DESCRIPTION OF THE DRAWINGS

Preferred example embodiments of the invention are illustrated in the figures, in which the same indexes denote the same or functionally identical features. In detail, the figures show:

FIG. 1: A transmission;

FIG. 2: A drive input of a test rig;

FIG. 3: The range of movement of an output shaft of the transmission; and

FIG. 4: A positioning mechanism.

### DETAILED DESCRIPTION OF THE PREFERRED EMBODIMENTS

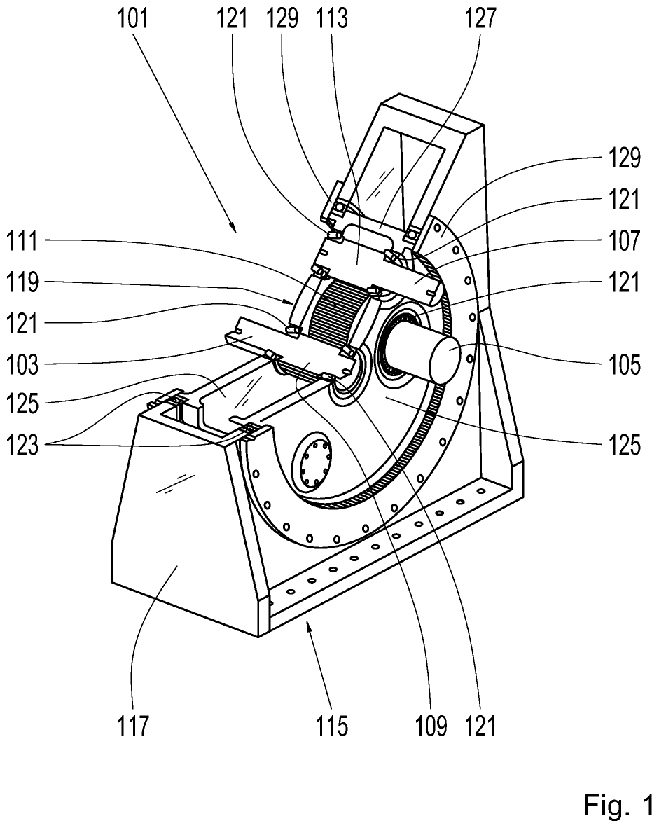

A transmission 101 according to FIG. 1 comprises a first shaft 103, a second shaft 105 and a third shaft 107. In addition three gearwheels are present—a first gearwheel 109, a second gearwheel 111 and a third gearwheel 113. The first gearwheel 109 is mounted on the first shaft 103 in a rotationally fixed manner, the second gearwheel 111 on the second shaft 105 and the third gearwheel 113 on the third shaft 107. The second gearwheel 111 meshes with both the first gearwheel 109 and the third gearwheel 113.

A housing 115 of the transmission 101 is a multi-component structure. It comprises a body 117 and a rotatable part 119. The first shaft 103, the second shaft 105 and the third shaft 107 are rotatably mounted in the rotatable part 119. For that purpose roller bearings 121 are set into the rotatable part 119.

In turn, the rotatable part 119 of the housing 115 is mounted in the body 117 and can be rotated by virtue of two roller bearings 123. The rotatable part 119 and the first shaft 103 are arranged concentrically so that their rotation axes coincide. In contrast, a rotational axis of the second shaft 105 and a rotational axis of the third shaft 107 in each case are located a distance away from the rotational axis of the first shaft 103. As a result, when the rotatable part 119 of the housing 115 is rotated the second shaft 105 and the third shaft 107 move along a circular orbit around the first shaft 103 or its rotational axis.

The rotatable part 119 of the housing 115 has two disk-shaped sidepieces 125. The sidepieces 125 are connected to one another by means of axially extending transverse struts 127. The roller bearings 121 in which the shafts 103, 105 and 107 are mounted are set into the sidepieces 125.

Screwed into the body 117 of the housing 115 are two ring gears 129. Respective pinions—not shown in FIG. 1—engage in each of the ring gears 129. The pinions are driven by a motor which is accommodated in the rotatable part 119 of the housing 115. That is how the rotatable part 119 can be rotated.

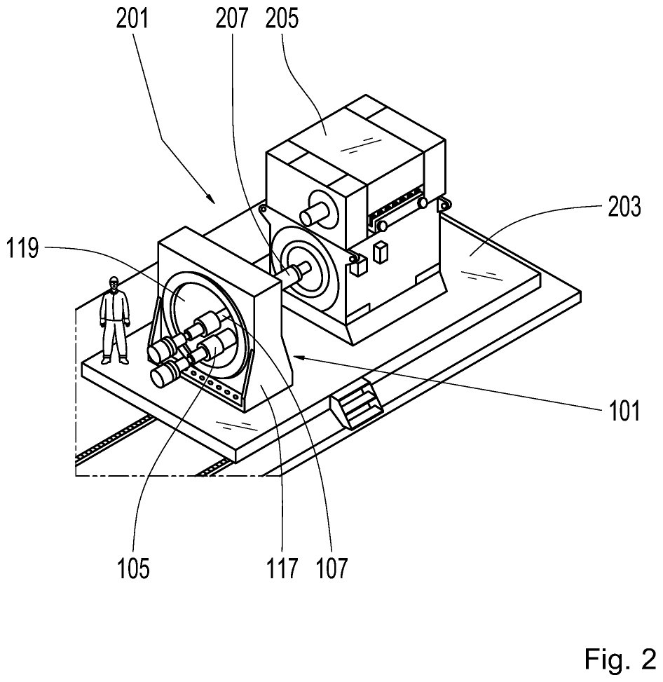

FIG. 2 shows part of a test rig 201 which comprises the transmission 101 shown in FIG. 1. The body 117 of the housing 115 of the transmission 101 is fixed on a platform 203. Likewise, a motor 205 is fixed on the platform 203. An output shaft 207 of the motor 205 is connected rotationally fixed to the first shaft 103 of the transmission 101.

The test rig 201 comprises a mechanism with which the platform 203 can be displaced horizontally along two axes.

Instead of the motor 205, the arrangement in FIG. 2 can comprise a generator, whose input shaft is connected rotationally fixed to the first shaft 103 of the transmission 101. In a back-to-back test rig, an arrangement according to FIG. 2 and an arrangement with a generator are positioned opposite one another.

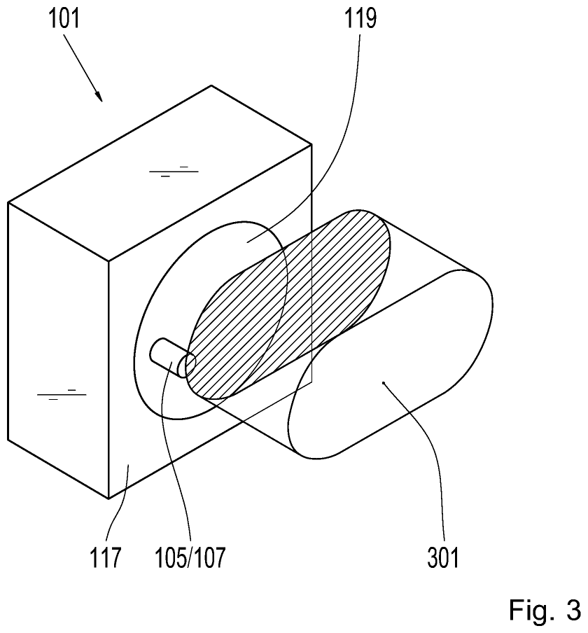

A positioning range 301 of one of the two eccentrically arranged shafts 105, 107 is illustrated in FIG. 3. The positioning range 301 is covered by superimposing a horizontal displacement path of the platform 203 and rotation of the rotatable part 119.

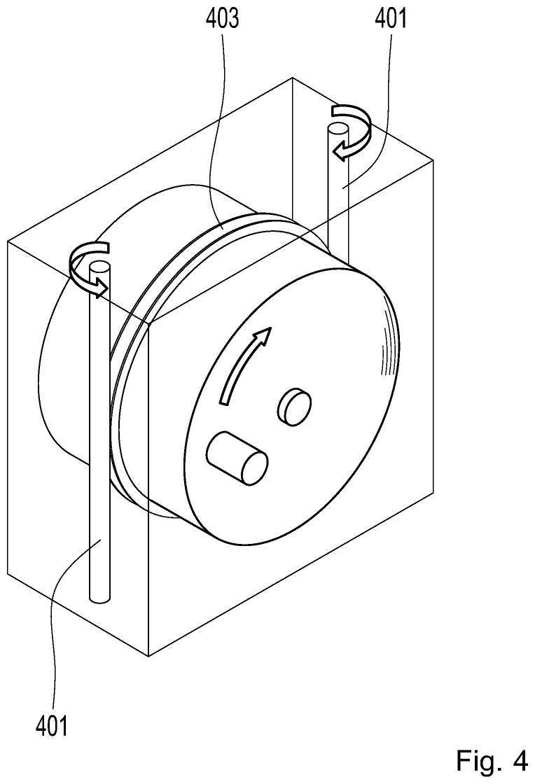

A mechanism for rotating the rotatable part 119 is shown in FIG. 4. The mechanism comprises two worm gears 401, which engage in a worm gearwheel 403 and thus form a worm gear system. The worm gearwheel 403 and the rotatable part 119 of the housing 115 are connected to one another in a rotationally fixed manner. A central axis of the worm gearwheel 403 coincides with the rotational axis of the rotatable part 119. By rotating the worm gears 401, the worm gearwheel 403 and hence the rotatable part 119 are now rotated about the rotational axis.

### INDEXES

101 Transmission
103 First shaft
105 Second shaft
107 Third shaft
109 First gearwheel
111 Second gearwheel
113 Third gearwheel
115 Housing
117 Body
119 Rotating part
121 Roller bearings
123 Roller bearings
125 Sidepiece
127 Transverse strut
201 Test rig
203 Platform
205 Motor
207 Driveshaft 103
301 Positioning range
401 Worm gear
403 Worm gearwheel

1-10. (canceled)

11. A transmission (101) comprising:
a rotatable structure (119),
a first shaft (103),
a second shaft (105);
the first shaft (103) and the second shaft (105) respectively being either an input shaft or an output shaft of the transmission (101);
the first shaft (103) and the second shaft (105) being mounted in and rotatable relative to the rotatable structure (119);
a rotational axis of the first shaft (102) and a rotational axis of the rotatable structure (119) being identical;
a rotational axis of the second shaft (105) and the rotational axis of the rotatable structure (119) being spaced apart from one another;
two ring gears (129) being screwed to a body (117) of a housing (115) of the transmission (101),
a pinion engages in each of the ring gears (129), and
the pinions are driven by a motor which is incorporated in the rotatable structure (119) of the housing (115), and, in that way, the rotatable structure (119) being rotatable such that when the rotatable structure (119) is rotated, the rotational axis of the second shaft (105) moves along a circular path about the axis of the rotatable structure (119).

12. The transmission (101) according to claim 11, further comprising a first gearwheel (109) and a second gearwheel (111), the first gearwheel (109) and the second gearwheel (111) mesh with one another;
the first gearwheel (109) is rotationally fixedly connected to the first shaft (103); and
the second gearwheel (111) is rotationally fixedly connected to the second shaft (105).

13. The transmission (101) according to claim 11, further comprising a third shaft (107);
the third shaft (107) is either an input shaft or an output shaft of the transmission (101);
the third shaft (107) is mounted to rotate in the rotatable structure (119); and
a rotational axis of the third shaft (107) and the rotational axis of the rotatable structure (119) are spaced apart from one another.

14. The transmission (101) according to claim 13, further comprising a first gearwheel (109) and a second gearwheel (111), the first gearwheel (109) and the second gearwheel (111) mesh with one another;
the first gearwheel (109) is rotationally fixedly connected to the first shaft (103);
the second gearwheel (111) is rotationally fixedly connected to the second shaft (105);
a third gearwheel (113) meshes with either the first gearwheel (109) or with the second gearwheel (111); and
the third gearwheel (113) is rotationally fixedly connected to the third shaft (107).

15. The transmission (101) according to claim 11, wherein the housing (115) has a first part (119) and a second part (117);
the first part (119) is mounted to rotate in the second part (117); and
the first part (119) constitutes the rotatable structure.

16. An arrangement for testing a first transmission unit to be tested, the arrangement comprises:
a first transmission (101) having a rotatable structure (119);
a first shaft (103);
a second shaft (105);
the first shaft (103) and the second shaft (105) being respectively either an input shaft or an output shaft of the first transmission (101);
the first shaft (103) and the second shaft (105) being mounted in and rotatable relative to the rotatable structure (119);
a rotational axis of the first shaft (102) and a rotational axis of the rotatable structure (119) being identical;
a rotational axis of the second shaft (105) and the rotational axis of the rotatable structure (119) being spaced apart from one another;
two ring gears (129) being screwed to a body (117) of a housing (115) of the first transmission (101), a pinion engaging in each of the ring gears (129), the pinions being driven by a motor which is incorporated in the rotatable structure (119) of the housing (115), and, in that way, the rotatable structure (119) being rotatable such that when the rotatable structure (119) is rotated, the rotational axis of the second shaft (105) moves along a circular path about the axis of the rotatable structure (119); and
an input or an output shaft of the first transmission unit to be tested is connectable, in a rotationally fixed manner, to at least one of the second shaft (105) and to a third shaft (107) of the first transmission (101).

17. The arrangement according to claim 16, further comprising at least one of a drive unit (205) with a drive input shaft (207) and a drive output with a drive output shaft; and
the drive input shaft (207) or the drive output shaft is rotationally fixedly connected to the first shaft (103) of the first transmission (101).

18. The arrangement according to claim 16, further comprising at least one horizontally movable platform (203); and
at least one of the first transmission (101) and the drive unit (205) and the drive output are fixed on the platform (203).

19. The arrangement according to claim 16, wherein the input shaft of the first transmission unit to be tested and an input shaft of a second transmission unit to be tested are rotationally fixedly connected to one another; and
the first transmission unit to be tested and the second transmission unit to be tested have identical structures.

20. The arrangement according the claim 19, further comprising a second transmission, an output shaft of the second transmission unit to be tested is rotationally fixedly connected to at least one of a second shaft and a third shaft of the second transmission;
the drive input shaft (207) of the drive unit (205) is rotationally fixedly connected to the first shaft (103) of the first transmission (101); and
the drive output shaft of the drive output is rotationally fixedly connected to a first shaft of the second transmission.

21. A testing arrangement for testing at least one transmission unit, the testing arrangement comprising:
at least a first transmission having a transmission housing including a housing body and a rotatable structure;
first and second shafts, one of the first and the second shafts being an input shaft of the first transmission and the other one of the first and the second shafts being an output shaft of the first transmission;
the first and the second shafts being mounted in the rotatable structure such that the first and the second shafts are rotatable relative to one another and relative to the rotatable structure;
the first shaft defining a first rotational axis, the second shaft defining a second rotational axis, and the rotatable structure defining a further rotational axis;
the first and the further rotational axes being coaxially aligned with one another;
the second rotational axis being parallel to but radially offset from the first and the further rotational axes; and
first and second ring gears being fixed to the housing body of the transmission housing, a first pinion engaging with the first ring gear, and a second pinion engaging with the second ring gear, the first and the second pinions being driven by a motor which is incorporated in the rotatable structure of the transmission housing such that when the first and the second pinions are driven by the motor, the rotatable structure rotates about the further rotational axis and the second rotational axis of the second shaft moves along a circular path about the further rotational axis of the rotatable structure.
